(19) United States
(12) Patent Application Publication
(10) Pub. No.: US 2022/0216916 A1
(43) Pub. Date: Jul. 7, 2022

(54) FIBER NETWORK DIAGNOSTIC SYSTEM AND METHOD

(71) Applicant: VTrum Group LLC, Alpharetta, GA (US)

(72) Inventor: Julianne Compann, Gainesville, GA (US)

(21) Appl. No.: 17/144,123

(22) Filed: Jan. 7, 2021

(51) Int. Cl. H04B 10/077; H04B 10/272; H04Q 11/00

(52) U.S. Cl. CPC H04B 10/0775; H04B 10/0773; H04B 10/0771; H04Q 11/0067; H04B 10/272

(57) ABSTRACT

A fiber diagnostics system facilitates testing, troubleshooting, tracking, identifying and logging information pertaining to fiber optic networks and their associated elements, including aggregated upstream and downstream statistics and trouble identification for all ports and services on the PON (Passive Optical Network), including Optical Line Networks and Optical Network Terminals (OLNs and ONTs). Traffic and network activities may be viewed as a whole or may be isolated to focus on specific networks, segments, WANs or LANs and individual client locations and devices, including devices residing on the customer premises beyond the point of demarcation.

### BACKGROUND OF THE INVENTION

### 1. Field of the Invention

The invention relates generally to diagnostic testing and trouble identification within fiber optic networks that are deployed to provide high bandwidth communications to home and business facilities. The invention provides aggregated upstream and downstream statistics and trouble identification for all ports and services on the PON (Passive Optical Network), including Optical Line Networks and Optical Network Terminals (OLNs and ONTs). Real-time indication of traffic and network activities may be viewed as a whole or may be isolated to focus on specific networks, segments, WANs or LANs and individual client locations and devices, including devices residing on the customer premises beyond the point of demarcation.

### 2. Related Art

The devices, features and functions described herein are intended to address shortcomings in existing diagnostic testing and trouble identification methodologies implemented to diagnose and troubleshoot network and client facilities, especially those currently available to be deployed in conjunction with fiber optic cable and PON technologies. For example, currently available portable testing devices are often large, difficult to use, require significant power resources to power them and generally have significant cost-of-use ratios. Some current methodologies do not support real-time traffic analysis or network/client device status in real-time. Other systems have other deficiencies as to the needs of a diagnosing and troubleshooting networks that include fiber optic cable and PON technologies. For example, broadband diagnostic systems that are designed to perform diagnostics on cable, xDSL, or DOCSIS compliant systems may not provide for the testing and diagnostic needs to support fiber optic cables, fiber optic network facilities, optical carrier (OC) switches, aggregators and other network equipment that is necessary in supporting the deployment of optical networks. Unlike DOCSIS, for example, fiber systems are not typically configured in compliance with a standard interoperability protocol. As one example, in DOCSIS, polling integration methodology is standardized. This is not the case across various fiber systems. One of skill in the art would also understand that diagnostic systems configured for cable, xDSL networks and/or DOCSIS compliant systems are able to track various analog metrics. However, a fiber diagnostics system needs to be capable of measuring optical metrics.

Further, current fiber diagnostics tools, such as Element Management Systems (EMS), provide some diagnostic testing of fiber networks, but are limited in the scope of information that can be shared between the network and testing facilities. Moreover, in part due to the limited information available, such systems are regarded as not having a user-friendly graphical interface that makes it possible to see key metrics in one place.

Therefore, a need exists to provide a lower cost, flexible and highly portable method in which to perform diagnostic testing and trouble identification from remote (field) locations where larger testing devices with higher resource requirements are not desirable. There is also a need to facilitate testing at virtually every point across one or more fiber networks on both the carrier (network side) as well as to the client demarcation point, and to the CPE devices residing on the customer premises beyond the client demarcation point.

The Fiber Diagnostic System and Method described herein (referred to as the fiber diagnostics system) also addresses additional unique and specific needs, including (but not limited to) combining multiple testing capabilities, platforms and architectures into a single system. The fiber diagnostics system introduces new features and functions to improve testing and troubleshooting capabilities, as well as providing new ways to display and actively compare analytic data. While the fiber diagnostics system utilizes both wired (PCs, laptops, desktops, main frames, test systems and other devices) and wireless technology (like smartphones, pads, tablets and other communications devices), the examples and drawings herein contemplate operation from a standard PC in order to ease understanding and provide clarity to the submission. One of skill in the art would understand that this example would apply to other wired and wireless technology.

The fiber diagnostics system is capable of utilizing multiple languages simultaneously, whether in the same network or across multiple networks, that are currently being deployed by newer systems to enable enhanced testing and troubleshooting information to be shared between devices and displayed by the fiber diagnostics system. One such language (among many) utilized by the fiber diagnostics system is SSH (Secure Shell) protocol. SSH protocol allows computers to utilize HTTP and hypertext to share information between them such as enabling the testing and diagnostic content of entire web pages to be presented through the fiber diagnostics system. Another language/protocol incorporated in the fiber diagnostics system is NETCONF. NETCONF is a protocol that is designed to install, manipulate, delete and completely reconfigure the configuration of network devices. This enables the fiber diagnostics system to go beyond providing testing and diagnostics metrics, allowing the system to replace and rebuild entire configurations for network devices such as switches, routers and the like without affecting the capabilities of the fiber diagnostics system, even if multiple languages are utilized in the same network.

The fiber diagnostics system disclosed herein also resolves usability problems with existing systems. It is designed to allow for the presentation of aggregated metrics in a single screen.

From the discussion that follows, it will become apparent that the present invention addresses the deficiencies associated with the prior art while providing numerous additional advantages and benefits not contemplated or possible with prior art constructions.

### SUMMARY OF THE INVENTION

The fiber diagnostics system disclosed herein provides testing and diagnostic capabilities for the purpose of identifying failure and trouble mechanisms that exist in the passive optical network (PON), optical line terminals (OLT) and optical network terminals (ONT) as well as on client premises and client devices such as modems, routers, switches and other CPE (Customer Premises Equipment) facilities. As will be described herein, the fiber diagnostic system includes functionality allowing testing, monitoring and troubleshooting across fiber networks and sub-networks as well as trouble isolation by client, by device and by path (transmit or receive). Moreover, the fiber diagnostic system can isolate and detect network and CPE trouble as it occurs, and provide a record of the trouble type, when the trouble first appeared, how long it has been present and when/if the trouble is cleared and the service restored. In addition, the diagnostic system presents overall and aggregated metrics on a single user-friendly screen. A user can then, when desirable, obtain more detailed information on other particular portions of the system.

As is known in the art, fiber carrier facilities provide a significant speed increase as well as capacity to carry far more voice, data and broadband traffic than traditional copper-based facilities. As the technology for network and client-based fiber deployment continues to expand, the fiber carrier facility (network side) is being deployed closer to the clients' geographic location. In many geographic areas, fiber is now provided by carriers and providers directly to the home or office point of demarcation, providing the fastest and highest bandwidth services available to support consumer, business and enterprise voice and data traffic.

The fiber diagnostics system is developed to address the growing deployment of fiber optic network facilities, and further the need for fast and flexible testing and diagnostic capabilities. The fiber diagnostic system provides a light weight, highly portable and configurable method to facilitate testing at virtually every point across one or more fiber networks on both the carrier (network side) as well as to the client demarcation point, and to the CPE devices residing on the customer premises beyond the client demarcation point. The fiber diagnostic system is intended to have the flexibility to be deployed on any portable computing device, including laptop computers, smart phones, tablets, giving technicians and field engineers the flexibility of both wired and wireless testing of the network facilities, network routing and switching devices as well as any device that may be present on a client's local area network (LAN).

The fiber diagnostic system is accessible both locally for the technician or engineer directly interacting with the system, as well as remotely from testing and operations centers, including NOC (Network Operation Center) locations. The information being monitored and processed through the fiber diagnostic system can be accessed simultaneously both locally and remotely, enabling network operations staff to communicate directly to the on-site staff performing the troubleshooting and network monitoring functions. The advantage to this is that all parties, both local to the circuit being actively monitored and remote from a NOC or other location can all see network activities and testing as it occurs. Real-time monitoring of fiber signals including (but not limited to) transmit and receive signal strengths, packet loss, active alarms, outages, and many other real-time aspects of the network and client equipment functionality can be viewed.

In a preferred embodiment, the fiber diagnostics system provides a user-friendly data aggregation screen that displays information about the elements being tested by the system. This aggregation screen allows a technician to view information about multiple parts and aspects of the system without having to navigate multiple screens to get information from across the system. The system also enables active viewing and interaction with any point of trouble within one or more fiber networks or sub-networks. As an example, an enterprise client may be experiencing trouble with an AVO (Audio and Video Over fiber) signal. This signal can be actively monitored, enabling the technicians and engineers to quickly determine the path (transmit or receive) of the trouble as well as the origin point of trouble, up to and including trouble that originates from the user/customer side of the demarcation point. As is known in the art, the demarcation is typically defined as the point of the network wherein the facility providing the service is handed off to a customer. These demarcation points typically reside in fiber terminals at the customer location either inside or outside of the physical facility.

As another example, in cases of multi-tenant facilities (MTF) or campus environments, the fiber diagnostic system can isolate and view active and passive portions of the network as well as traffic, alarms and other network indicators and conditions on a channel specific level. These signals may be monitored on the network side of the demarcation point (the carrier/provider side) and/or the user/customer side of the network residing behind the point of demarcation. In a preferred embodiment, a fiber facility may be handing a service off to an office building or other MTF. The fiber diagnostic system can actively and passively monitor and collect data (including any alarm activity) on the user/client facility up to and including the service location such as a specific office residing within the office building. In cases wherein services are provided to MTF's such as a call center, the fiber diagnostic system can actively and passively monitor and collect data (including any alarm activity) to the desk within the call center where the signal facility is handed off to the client device such as a desktop computer, a land-line based telephone or the like. It is not required for the technician or network tester to be physically/geographically on the customer/user premises to view traffic going to and from the customer/user owned equipment. The technician or network tester can look at any point of the network, from any point in the network using the fiber diagnostics system.

Trouble indications such as alarms, signal levels being out of compliance or other conditions indicating poor performance can be identified and tracked as a grouping. As an example, the fiber diagnostics system may be queried to provide information on all signal levels below a threshold within a certain portion of a network, or the entire network. In a preferred embodiment, the fiber diagnostics system may be queried to provide all alarm indications within a specific area code or a specific postal code. This granularity can be tightened down to a geographic location such as a community, neighborhood, city block, home or office, and all the way down to the CPE equipment residing in the location.

Diagnostic, data and traffic information collected by the fiber diagnostics system may be actively viewed simultaneously by both the technician working directly with the local device and performing the testing/troubleshooting, as well as by the support personnel that are in a remote location (such as a testing or NOC center) away from the physical tests being performed. In one or more embodiments, a local tester (physically collocated with the fiber diagnostic system) can be viewing the same information from the system at the same time as an engineer located in a NOC center in a different geographic location. This functionality enables to the two engineers testing and/or troubleshooting the network to see the same information and discuss actions to resolve issues in real-time.

The fiber diagnostics system also enables collection, storage, parsing and dissemination of the subject diagnostic information from a local or remote location, or from both locations simultaneously. In one or more embodiments, a technician may have collected fiber network traffic data in order to detect patterns that may impact the level of service. The technician may access and review this collected data from the fiber diagnostics local device, while at the same time the historical collected data may be simultaneously viewed at a NOC center by a different technician. Further, this information can be disseminated among parties based on the needs of the technician and/or troubleshooting team. Again, this collaborative engagement with passive, active and historical data enables faster trouble isolation, identification and resolution.

The fiber diagnostics system provides a method to view aggregated statistics, traffic and data on both upstream and downstream directions. Each PON port can be viewed individually, as can be the devices associated with the reference PON port. Specifically, in one or more embodiments, a technician (either locally or remotely) can select a PON port and view all of the traffic and connected devices associated with that port. By selecting one or more devices shown on a given port, the fiber diagnostics system can provide detailed information about the devices connected, including device type and location, as well as any customer information associated with the subject port. Traffic present at the subject customer device is also visible and may be monitored in an active (live) or passive (stored and recalled) fashion.

A method for determining the effective range of a trouble associated with a fiber network, or a geographic or physical portion thereof is also provided. In one or more embodiments, an alarm indication such as a hard failure, soft failure or potential (pending) failure may be selected for viewing through the fiber diagnostics system. Any PON or connected device associated with the subject trouble can be viewed from the fiber diagnostics system, giving the technicians a method in which to notify customers of active, pending or potential service interruptions. The effective range of trouble also includes the client (CPE) side of the network, and the associated devices. As an example, a network signal may show on the fiber diagnostics system as being valid from the PON to the customer (home or office) point of demarcation, but show as invalid beyond the point of demarcation. This enables the technician/engineer to identify the point of failure as the link between the customer's point of demarcation, and the customers own equipment. Expressly, the provider can tell the customer that the problem exists on their (customers) premise. By providing detailed geographic diagnostic data, the fiber diagnostics system allows the service provider to proactively diagnose and potentially fix cases of trouble before an outage can be reported.

As an example of a preferred embodiment, a local technician may be using the fiber diagnostics system wirelessly at a customer's location. The technician can see the traffic (both transmit and receive) going into and out of the point of demarcation that resides at the customer's premise. Further, the technician can see that transmit and receive signals beyond the customer's point of demarcation (on the customer's LAN) are valid for all but one of the customer's personal devices. The technician can select the customer's contact information directly from the diagnostics screen and contact them while running diagnostic monitoring and testing, including the active and/or passive collection of data and traffic patterns to determine trending. The technician can identify for the customer the point on the customer's local network where the trouble resides in real time.

Customers can also be queried through the fiber diagnostics system directly by their contact information. In one or more embodiments, a customer can report a case of trouble to the fiber carrier and the carrier can see the customer's network through the fiber diagnostics system. Viewing includes all points on ingress/egress as well as the signals (transmit and receive) going into and out of the customer premises on both sides of the point of demarcation. Further, the view can be expanded beyond the local level to view all network elements up to and including the optical carrier primary fiber loop.

Traffic and data can be collected, viewed and parsed by the fiber diagnostics system at varying levels of granularity. As an example, a technician may view a customer's point of demarcation and review all traffic in real time that is being delivered to and from the customer's computer and other equipment served on the customers LAN. Signal levels can be actively or passively monitored and stored to enable the creation of trend lines and patterns over a period of time. Typically, the information is collected for a period of as little as a few minutes to as much as a few months, depending on the needs of the technician troubleshooting the service(s). The information can then be parsed and broken out by minute, hour, day, date, week, month and year. This enables the technician to determine patterns that are presented through the collection and the parsing of the subject customer traffic and data.

The fiber diagnostic system also provides a map function that enables a technician (either locally or remotely) to view service areas in a map view. The map view will give specific information about network elements and PONs including the specific street address, building and suite locations. This enables quick and easy viewing of network elements and their associated status. Color coding provides the technician with a simplified view that shows traffic operating properly in colors such as green, while traffic underperforming may be shown in yellow. Traffic that is stopped or otherwise in full alarm may be shown in red. The colors enable a quick method for immediately spotting geographic areas of trouble. Colors may be assigned based on the needs of the carrier providing the fiber optic services.

Unique identification information pertaining to both network and customer premises equipment may also be collected and stored by the fiber diagnostics system. As an example, a machine (MAC) code address may be provided by a manufacturer of a device such as a smart phone, modem, tablet, network switch, network router, hub or other network or customer element. These MAC codes may be collected and stored by the fiber diagnostics system in association with their network or customer location, and under a network or customer identifier. In one or more embodiments, the fiber diagnostic system may collect the MAC or other identifying coding from all network switches, hubs and network routers associated with a neighborhood. As the local or remote technician access the fiber diagnostics system, a screen showing the geographic area and the associated switches, hubs and routers may be identified by their MAC code. The technician can select the specific network element for granular viewing, at which point further detailed information about that device is presented. This information includes, but is not limited to MAC codes, serial numbers, installation dates, testing history and dates, operational times and other factors that enable the technician to determine information about the network element, when it first appeared on the network, who installed it, who provisioned it and any trouble reports associated from a historical log.

The fiber diagnostics system provides detailed information on all fiber optic networks and their associated elements including, but not limited to optical line terminal(s) (OLT), optical network terminal(s) (ONT), passive optical network (PON) and audio-video over fiber (AVO) among others.

The fiber diagnostics system provides a user interface that displays information about the fiber network being tested, the devices associated and the customers connected to the network. This information can be viewed as a general (side-by-side) view that gives the technician or engineer an overall view of the network or network segment being viewed, including all traffic and traffic patterns associated, all clients connected to the network or segment, all client devices, all network handoffs and network equipment associated, including a map showing the geographic area and the deployment of the devices, hardware and fiber cable facilities associated.

A technician either locally or remotely can select any section or any component or customer on the associated user interface and instantly get a granular view of the entire network. The views include, but are not limited to, all transmission and receive signal levels, the amount of data traffic active on each port, the origin and destination of all traffic, and the signal levels and stability of each network segment being viewed. As the technician wishes to get more granular, they can access a facility and get more details. As an example, a technician may be local and using the fiber diagnostics system through a tablet computer. The technician can select (by touching the screen) a fiber cable for a more granular view. The new granular view will show the cable type, the cable makeup, the cable minimum and maximum traffic specifications, the actual traffic being moved through the cable and the like. The technician can then get more granular by zooming into the cable facility to separate out the transmission and receive signals (going to and from the network to the customer as an example) and get detailed information about the state of the current traffic in either or both directions. Further granularity allows the technician to determine the type of traffic, the origin point of the traffic and the recipient point of the traffic. Data can be monitored in real time or may be collected and parsed by the fiber diagnostic system to determine traffic patterns, signal levels and other metrics that enable the technician to make recommendations concerning the cable facility.

The fiber diagnostics system reports, stores, parses and analyzes network and device data and errors, including but not limited to, ONT errors such as BIP, GEM and Burst, any ONT alarms and the like. Data port errors may include upload errors, download errors, packet transfers and transfer errors. Voice and video ports may report SIP registration errors, video port outages and optical signal issues on both the send and return paths. Downstream and upstream error reporting may include signal level performance, including specified performance parameters, packet loss, signal loss and the like. Other information reported may include, but is not limited to device operating temperatures, laser transmit power output(s), device activity status for each PON device, bandwidth utilization, fiber health and other metrics for determining the service levels and overall performance of the subject fiber optic network and its associated elements.

The fiber diagnostics system provides the capability to actively and passively monitor and collect data about any network service that it is interfacing. This traffic and data may be collected between specifically designated points within a network, specifically designated network sections and/or areas, between selected points, to and from selected network devices, and across one or more channels concurrently. The system further provides for separation of data such as between a signal being sent from a network element such as an Optical Line Terminal (OLT) to a device such as a fiber demarcation point at a customer location. By separating out the transmit and receive sections of each individual channel of traffic within a network, a high level of granularity may be achieved in the data collection and parsing, allowing for rapid clearing of trouble or alarm conditions.

In a preferred embodiment, the user interface of the fiber diagnostics system can be configured to have a similar appearance and functionality to a diagnostics system that is used for a cable, xDSL, or DOCSIS compliant broadband network. One such broadband diagnostics system is disclosed in U.S. Pat. Nos. 9,112,718 and 10,820,219, both of which are incorporated by reference as if fully set forth herein. The use of a similar interface and/or functionality for both a fiber diagnostics system and a broadband diagnostics system would allow for individuals who use one system to at least be familiar with the user interface and capabilities of the other, which should increase efficiency at least as to the need for individuals to learn how to use different interfaces.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The components in the figures are not necessarily to scale, emphasis instead being placed upon illustrating the principles of the invention. In the figures, like reference numerals designate corresponding parts throughout the different views.

FIG. 1 discloses the primary functional elements of the fiber diagnostics system;

FIG. 2 illustrates some of the primary elements presented in an exemplary data and statistics screen;

FIG. 3 illustrates additional primary elements presented in an exemplary data and statistics screen;

FIG. 4 illustrates additional primary elements presented in an exemplary data and statistics screen;

FIG. 5 shows an exemplary customer signal and data activity screen;

FIG. 6 shows an exemplary ONT bandwidth utilization screen;

FIG. 7 shows an exemplary ONT upstream, downstream, temperature and bandwidth screen;

FIG. 8 shows an exemplary ONT status, transmit power and PON performance screen;

FIG. 9 shows an exemplary ONT customer status screen;

FIG. 10 shows an exemplary ONT customer performance screen;

FIG. 11 shows an exemplary ONT Map screen;

FIG. 12 shows an exemplary ONT device and data port screen;

FIG. 13 shows an exemplary ONT device, voice, video customer and map screen, and;

FIG. 14 shows an exemplary ONT advanced search screen.

### DETAILED DESCRIPTION OF THE PREFERRED EMBODIMENTS

In the following description, numerous specific details are set forth in order to provide a more thorough description of the present device. It will be apparent, however, to one skilled in the art, that the present functional aspects of the device may be practiced without these specific details. In other instances, well-known features have not been described in detail so as not to obscure the specific detailed claims of the device.

In general, the fiber diagnostics system disclosed herein is intended to provide detailed diagnostic and statistical information about a network and its associated elements (e.g., Optical Network Terminals, Optical Line Terminals, Audio/Video over fiber terminals, network multiplexers, switches and client devices residing on customer networks, and the like) being deployed, tested, accessed and configured thereon. The diagnostic information is provided for multiple purposes, including but not limited to testing, trouble shooting, diagnosing, identifying and facilitating for the deployment and management of the disclosed network elements. As will be described further below, the fiber diagnostics system may be provided, implemented and/or deployed in various physical embodiments including smartphones, tablets, PCs and other computing devices.

It is noted that one or more or all of the specific systems and methods may be provided as part of a single testing and troubleshooting system. In addition, it is contemplated that, though certain functionality is disclosed herein as being activated by particular user interface elements or controls (such as buttons or touch-screens), various user interface elements or controls could be used to access, activate or otherwise use the testing system described herein.

As previously stated, the fiber diagnostics system is intended to be deployed on mobile computing devices such as tablets, smartphones, laptop computers and other portable computing devices. The fiber diagnostics system may also be deployed at fixed locations on computing equipment such as in a Network Operations Center (NOC) or other location wherein network monitoring and troubleshooting may be conducted.

The functional aspects of the fiber diagnostics system will be discussed in the following sections. It is important to note that while other systems and methods will be obvious to one skilled in the art, the following disclosure is meant to provide specific functional detail about the preferred embodiments of the disclosure. It is further understood that while the fiber diagnostics system requires authorization to access, utilize and otherwise deploy in one or more troubleshooting devices, this disclosure assumes the criteria for authorized access has already been met with reference to the examples and disclosures that follow.

The functional modules and systems that comprise the fiber diagnostics system may be deployed as a whole system, or in a modular fashion by simply selecting the modules required for the given network task and adding them to the computing device used for network testing and/or troubleshooting. It is not required that the system be deployed as a whole, and may therefore be deployed in multiple devices and locations by one or more technicians or administrators working on one or more networks. Modular components of the system may also be deployed simultaneously through testing centers and devices, allowing the same tests to be run in multiple locations simultaneously utilizing a single system approach.

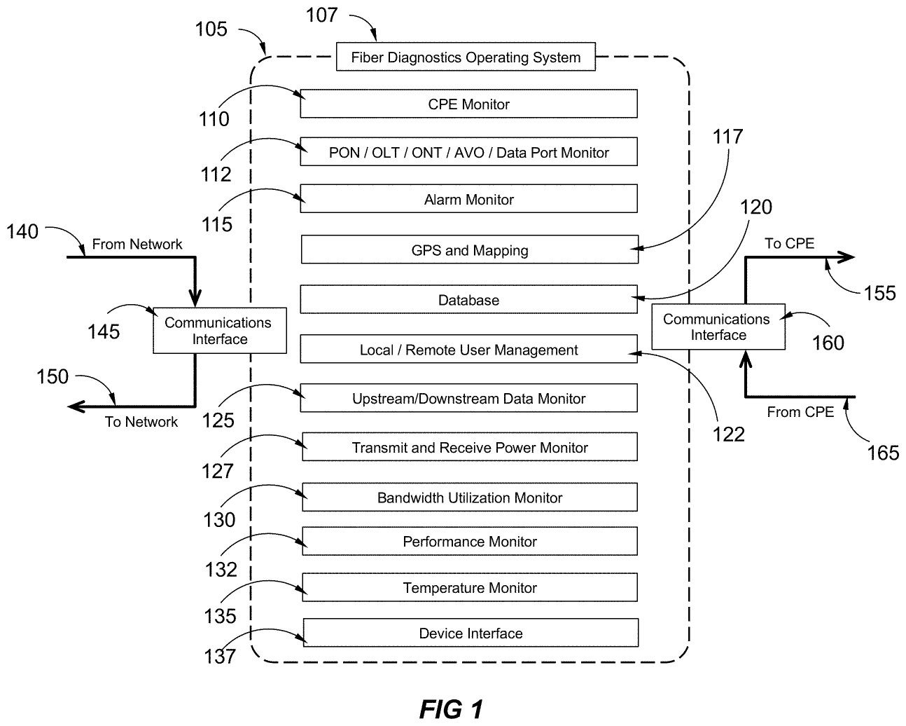

The functional modules and systems that comprise the fiber diagnostics system will now be disclosed with reference to FIG. 1. As can be seen in FIG. 1, the fiber diagnostics system 105 is comprised of multiple functional modules. Each module is intended to perform specific functions for both testing, troubleshooting, monitoring and data collection. The fiber diagnostics system 105 is controlled by the operating system 107 that enables communications and functionality between the subject modules. The CPE monitor 110 looks specifically at networks and devices that are beyond the point of network demarcation. Specifically, the point of demarcation is where the carrier or service provider network ownership terminates, and the customer or user network begins. The CPE monitor 110 can collect, analyze, parse and disseminate data to enable trouble isolation and transmit/receive traffic monitoring for all network facilities and elements residing on a customer premise. In some embodiments, the CPE monitor 110 may be accessed by third party services and may allow CPE manufacturers to enable signaling through their equipment to enhance testing, troubleshooting and diagnostic data collection. As an example, a service provider such as a telephone company may work with a third party such as a modem manufacturer to enable the modem manufacturer to provide information directly to the CPE monitor 110, creating an enhanced and more thorough view of the specific traffic, data and patterns associated with the CPE equipment.

Like all modules within the fiber diagnostics system, the CPE monitor is completely interactive. Specifically, a granular view of detailed traffic, alarm, signal, data and other diagnostic information may be presented to the technician utilizing the fiber diagnostics system by simply selecting the part of the network they wish to zoom into. Once selected, details about specific elements of that segment of the network are presented. Highly granular data points may be viewed by continuing to zoom into each functional element being presented to the user.

The PON, OLT, ONT, AVO and Data Port Monitor 112 is designed to specifically look at signals, data, transmit and receive paths, individual data channels and the like that are either originating from or terminating to the PON, OLT, ONT, AVO and Data Ports deployed in support of the fiber optic network.

The alarm monitor 115 collects and parses alarm information originating throughout the network as well as the CPE. More specifically, this module collects, disseminates and analyzes alarm information from all network devices, and any device sending an alarm signal from the CPE to the point of demarcation.

The GPS and mapping module 117 provides the exact geographic location and coordinates of all network elements as well as the location of the customer(s) being served by the fiber optic network.

The database 120 module stores (both locally and remotely) information provided by the fiber diagnostics system 105 modules show with reference to FIG. 1. Device storage on tablets, smartphones and other portable computing devices is limited. The database 120 module may be set to locally and/or remotely store specified data and traffic on any specific network or customer element, in any specific direction and between any specific network locations. As an example, data may be collected and stored using database 120 in a remote location such as a NOC center. The data being stored may originate from any point or any device deployed in the fiber network, as chosen by the technician engaging the fiber diagnostics system 105.

The local and remote user management 122 module manages access and command interfaces for both the technician at a remote location such as a NOC or test center (not pictured) and the local technician using the fiber diagnostics system 105 on their smart computing device locally. Both the local and remote users (not pictured) may access the same information provided by the fiber diagnostics system 105 simultaneously, or may view different information simultaneously. As an example, a local technician (not pictured) utilizing the fiber diagnostics system 105 may be looking at the customer LAN equipment through the CPE monitor 110, while simultaneously, the technician located at the NOC (not pictured) may be looking at network alarm status through the alarm monitor 115. By providing multiple users access to the tools within the fiber diagnostics system 105, trouble conditions can be cleared faster as multiple technicians can see the same or various elements within the subject network and discuss them in real time.

The upstream and downstream data monitor 125 looks at the channel and the specific path (transmit/receive) of the data being viewed. The upstream and downstream data monitor works in conjunction with all fiber diagnostic system 105 modules to enable granular viewing of specific data sets within specific channels and paths. As an example, a technician (not pictured) may wish to view alarms (via the alarm monitor 115) on just the upstream (network receive) path coming from a network element such as a fiber terminal (not pictured) to a fiber multiplexer (not pictured). The upstream and downstream data monitor 125 allows the subject technician (not pictured) to view only the data and only the path within a specific network segment they wish to view. As with all fiber diagnostics system 105 modules, deep levels of granularity may be attained by separating the individual upstream and downstream data paths utilizing the upstream and downstream data monitor 125.

The transmit and receive power monitor 127 allows viewing and data collection of signal levels on the transmit and receive paths of the selected data port, ONT, PON, AVO, OLT or fiber facility being scanned. The transmit and receive power monitor 127 also works directly with the upstream and downstream data monitor 127 to determine signal levels, line power and data levels. As with other modules, granularity may be increased by looking at smaller areas of the network facility, including specifically viewing individual network and CPE devices such as switches, multiplexers, fiber terminals, modems and the like.

The bandwidth utilization monitor 130 shows the amount of bandwidth being used in comparison to the amount of bandwidth available and/or allotted to the specific fiber device being scanned. As an example, a customer location such as a business may be experiencing low signal strength to their location. The bandwidth utilization monitor 130 will show the technician reviewing the circuit how much bandwidth is currently being used by the incoming or outgoing signal (depending upon the channel the technician is viewing) in relation to the total amount of bandwidth allotted and/or available to the reference customer.

The performance monitor 132 is used to gather and parse performance data on any and all ports, facilities, data channels, devices and CPE equipment in both upstream and downstream directions. The performance monitor 132 enables a comparison in service levels between what is specified by the network carrier and what is being experienced by the customers utilizing the service. The performance monitor 132 further can determine how specific network and CPE devices are performing by monitoring the signals (both transmit and receive in both upstream and downstream directions) that are entering and leaving a specified device. As an example, a technician may wish to determine how much a signal level changes while it moves through a piece of network equipment such as a fiber optic multiplexer. The incoming signals to the multiplexer may be viewed and compared to the outgoing signals to determine how well the multiplexer is functioning. As previously stated, this information may be stored locally or remotely, and may be called at any time by the local technician directly engaged in using the fiber diagnostics system 105, or may be called remotely by a technician residing in a network operations center (NOC) or other testing facility. The database 120 manages the collection and storage of the associated performance data, based on the configuration as determined by the fiber diagnostics system 105 provisioner.

The temperature monitor 135 can actively or passively monitor the temperature of devices, network and CPE facilities and cables. This information may be collected and stored locally on the fiber diagnostics system 105 or may be stored remotely. As with other monitors, the database 120 manages the storage and recall of the temperature monitor 135 data as provisioned by the fiber diagnostics system 105 provisioner.

The device interface 137 enables the fiber diagnostics system 105 to be installed in and communicate through the processors, memory and storage of the device which the fiber diagnostics system 105 is being installed on. As an example, the device interface 137 will recognize a host device such as an ANDROID operating system, an IOS operating system, a LINUX operating system, a WINDOWS operating system and other such systems that routinely manage and control the functions of devices such as smartphones, tablets, laptop computers and other computing devices. The device interface 137 supports user interface commands from any and all operating systems enabling the fiber diagnostics system 137 to function within the subject computing systems.

It is contemplated that a fiber diagnostics system 105 may be provided as a hardware device as well. For example, a fiber diagnostics system 105 may comprise one or more processors, memory devices, storage devices, communication interfaces, power sources, display devices, and the like or various subsets thereof, such as found in various computing devices. A processor may execute machine readable code stored on a non-transient storage device (excluding carrier waves and other signaling) to provide the functionality disclosed herein.

The communications interface 145 controls the fiber diagnostics system 105 communication for signals coming from 140 and going to 150 the network side of the facility being monitored. As an example, a technician actively monitoring the output (moving towards a customer) of a fiber multiplexer would interface with the subject fiber multiplexer through the communications interface 145 that controls the network side communications for the device.

In a similar fashion as the above, the communications interface 160 controls the communications going to 155 and coming from 165 the customer premises equipment (CPE). The fiber diagnostics system 105 may be engaged with network testing in a wired or wireless fashion, depending on the needs of the deployment and of the technician utilizing the fiber diagnostics system 105 for testing and monitoring of the circuit. It is not necessary for fiber traffic and/or signaling to “pass through” the fiber diagnostics system 105 in order to achieve accurate monitoring, testing and troubleshooting data and metrics. The fiber diagnostics system 105 can function normally in a monitoring and data collection capacity provided at least 1 communications port 145 or 160 is actively connected (wired or wirelessly) to at least one communications interface 145 or 160 port from the network 140 or from the CPE 165. As an example of this embodiment, a technician may be to interested in viewing only the signal strength coming out of a fiber multiplexer on the network side of a fiber optic network. The technician may connect (wirelessly or wired) to the communications interface 145 from network 140 port to enable the collection of the subject signal strength data. It is important to note that when the fiber diagnostics system 105 is wirelessly configured to look at a network, all ports (communications interface 145 and 165, along with from network 140, to network 150, from CPE 165 and to CPE 155) are automatically enabled and actively collecting and monitoring traffic. The technician or provisioner may choose to disable any of these ports locally or remotely at any time. Further, wired connections to the subject communications interface 145 and 160 ports 140, 150, 155 and 160 may be enabled and disabled locally or remotely at any time. The purpose of the individual port control is to enable complete isolation of a line, signal, or transmission path associated with any and all network elements to enable advanced troubleshooting to occur.

It is important to note that while the fiber diagnostics system 105 is also capable of functioning in support of facilities that are fed by copper and cable-type networks and their associated signals and alarm types, this disclosure is focused solely on the fiber optic testing and troubleshooting, and the functional elements associated.

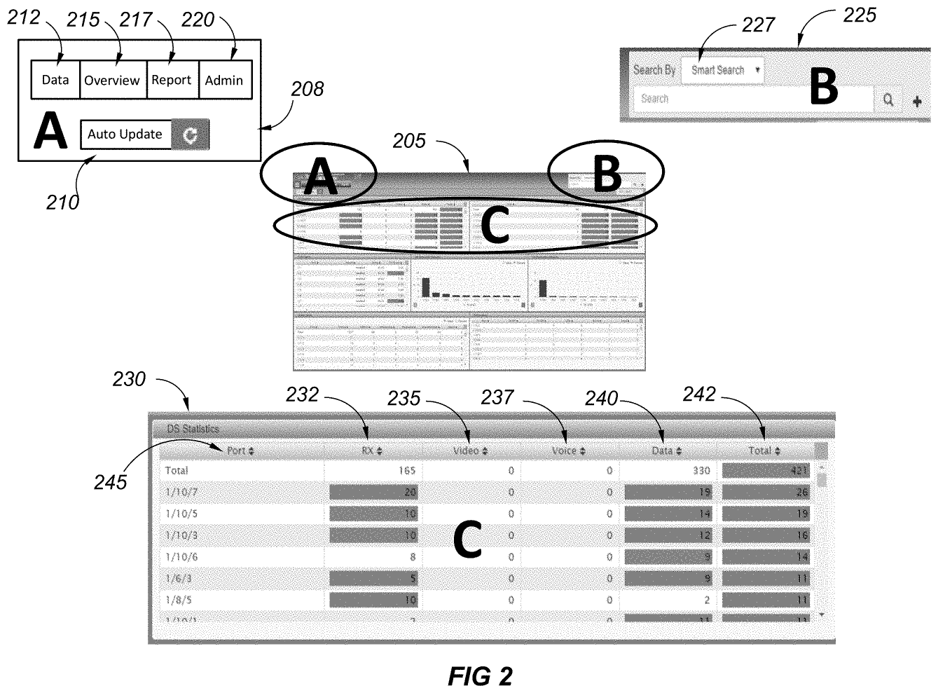

Information pertaining to the network being tested is presented to the local and the remote technician(s) through a series of user interface screens. Each screen provides detailed information about the network element(s) being viewed by the subject technicians. The user interface provides high granularity for viewing specific paths, devices, cables, facilities and equipment in both upstream and downstream directions, and in both the transmit and receive paths of the network, including data port information broken down by signal and by customer. An exemplary data user interface screen will now be discussed with reference to FIG. 2. It is important to note that while other functional and diagnostic elements exist within the reference data aggregation screen presented in FIG. 2, the discussion will be limited to disclosing the preferred embodiments.

As can be seen in FIG. 2 a data aggregation screen 205 is presented. Due to the small size of the data aggregation screen 205, the disclosure provides exploded views (A, B and C of 205, exploded to views A 210, B 225 and C 230) to show the functional elements. The top left portion of the data aggregation screen 205 is presented as reference 208, showing the selectable views available from the top left portion 208 of the data aggregation screen 205. As can be seen, the information provided by the user interface 205 can be presented as a data view 212, a general overview 215, a (printable) report view 217, as well as an administration panel 220 to enable detailed settings to support testing, monitoring and troubleshooting. An auto update function 210 is also provided that enables the technician to select and configure how the reference data aggregation interface 205 is updated. The auto update 210 can be configured for real-time (constantly updating) or may be broken into any time configuration from a few seconds to days or weeks at a time, depending on the needs of the technician monitoring the circuit. The auto update 210 may also be stopped entirely, enabling the current statistics presented through the data aggregation panel 205 to be studied. Screen capture and report capabilities 217 enable the technician to disseminate information directly from the data aggregation 205 (or any user interface screen within the fiber diagnostics system) to other network testers and troubleshooters in a real-time fashion. This allows for multiple technicians to view the same information simultaneously, greatly increasing the clear time of alarms and cases of trouble, including outages.

The top right portion 225 (B) of the data aggregation screen 205 provides detailed search capabilities to enable the technician to look for specific events that may have triggered an alarm or other circumstance wherein the network or CPE may not be performing to the configured metrics. The smart search capability 227 will be detailed later in this submission.

The center portion (C) of the data aggregation screen 205 is shown as reference 230. As can be seen, reference 230 is showing an aggregation of downstream (DS) data ports 245 that is broken down by receive 232, video 235, voice 237, data 240 and provides a total 242 of the signal levels and data ports currently being viewed through the subject screen 205. Any of the data points shown in 230 under any of the reference headings (232, 235, 237, 240 and 242) may be individually selected to present a more detailed view of the specific activities occurring on the subject reference port and the subject reference signal (receive 232, video 235, voice 237, data 240) being presented.

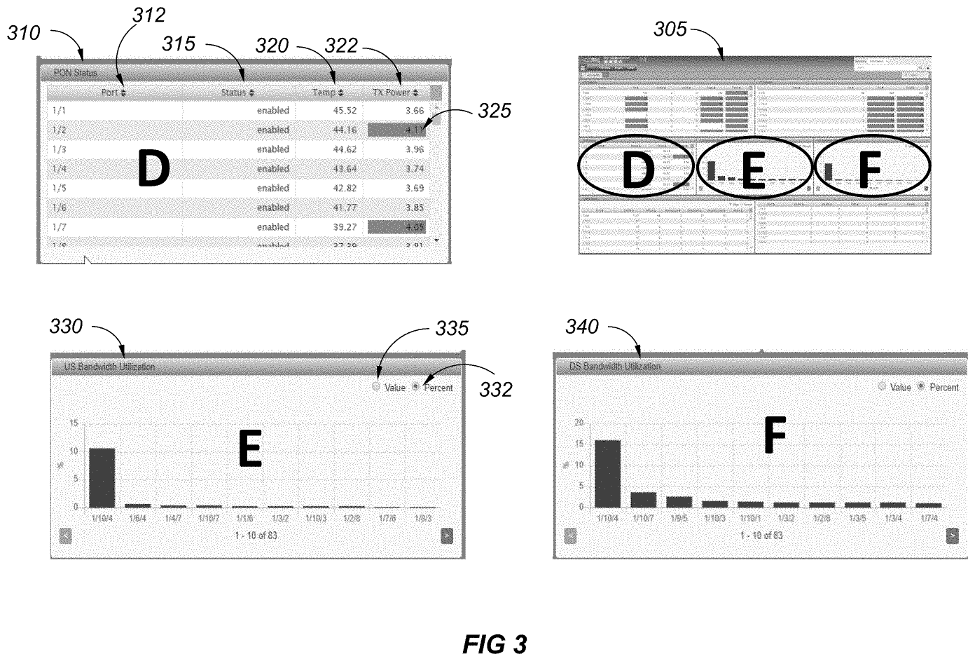

The data aggregation screen 205 is further disclosed with reference to FIG. 3. As can be seen in FIG. 3, the data aggregation screen 305 is broken out (D, E and F) to show additional functional elements being monitored by the subject fiber diagnostics system. With reference to FIG. 3, the PON (passive optical network) status portion 310 of the data aggregation screen 305 enables detailed views of each data port 312 as well as the current status 315 (enabled or disabled) of the subject port, the temperature 320 of the port and the transmit power 322 of the reference subject port. Any measurements that fall out of the specified port range of operation will be shown highlighted 325. While the diagrams provided in this disclosure are black and white, the fiber diagnostics system user interface supports displaying alarms and other indications of signal levels, temperatures or other status elements in multiple colors. Typically, a signal falling out of an acceptable range 325 will appear in RED or other color as chosen by the technician(s) engaging the fiber diagnostics system.

The upstream bandwidth utilization screen 330 provides detailed information about the bandwidth being used on the subject port. This information can be displayed as a percentage 332 or as a value 335 as required by the technician(s) engaging the fiber diagnostics system. In a similar fashion, the downstream bandwidth utilization 340 is also provided, offering the identical functional attributes as the upstream bandwidth utilization screen 330, giving the technician(s) a clear picture of the bandwidth utilization in both directions of network transmission.

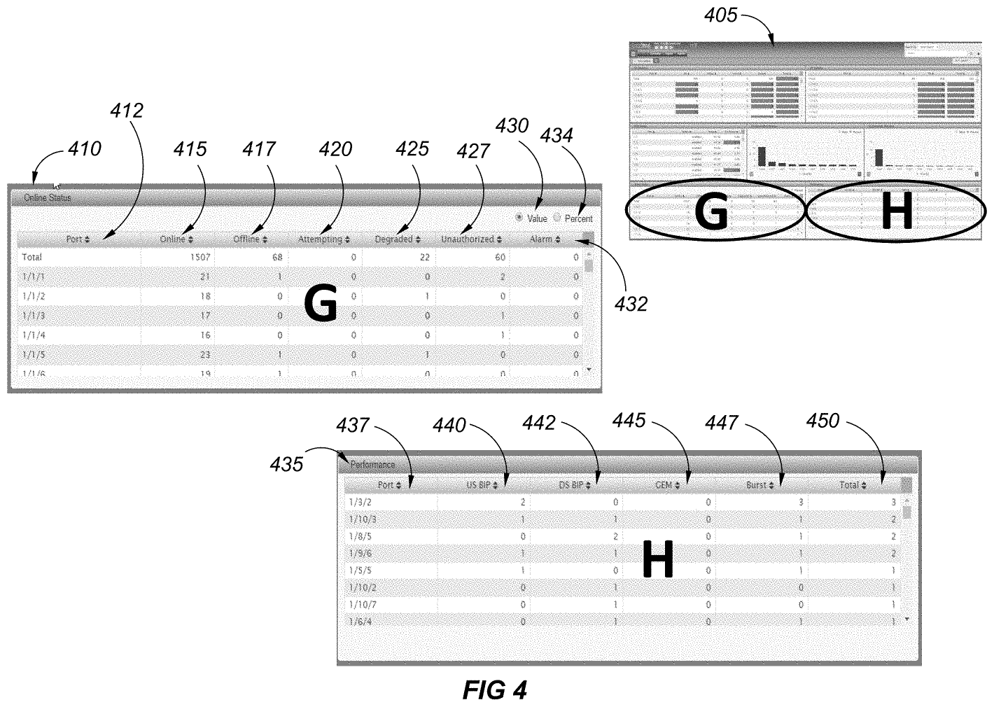

The data aggregation screen 305 is further disclosed with reference to FIG. 4. As can be seen in FIG. 4, the data aggregation screen 405 has been broken out into exploded views G 410 and H 435. The online status portion 410 of the data aggregation screen 405 provides detailed information about the port 412, the online 415 status in quantity of online ports, the offline status 417 in quantity of ports, the quantity of ports attempting to come online 420, the number of ports showing some level of degraded signal levels 425, the quantity of unauthorized access by ports 427 and the number of alarms experienced on each port 432. The online status information 410 can be presented through the screen as a value 430 or as a percentage. The details about each individual port give the technician(s) a clear picture of the utilization of each port on a by port basis, as well as the referenced status indications for each port.

The performance screen 435 provides detailed information about the performance of each port 437, detailing upstream BIP 440 (bit interleaved parity which is used to estimate bit error rates), the downstream BIP 442, the GEM 445 errors (G-PON Encapsulation Method. This is a method of data encapsulation over the G-PON network that uses variable length frames to transport ATM or Ethernet packets over the network), burst 447 errors and a total 450 of all error counts across all error types (440, 442, 445, 447) across all ports 437.

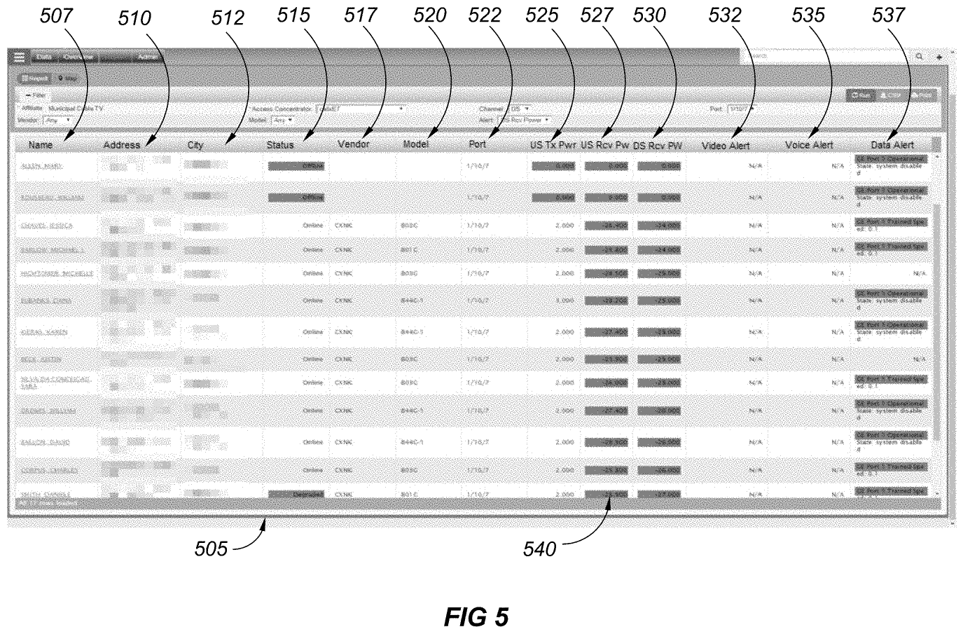

From the data aggregation screen 405, a technician can select any port shown on any provided menu screen such as the online status 410 or the performance 435 screen and expand that view to show the use of each channel within a given port. A customer view (as an example) will be shown when expanding the viewing area of a given port. An exemplary embodiment of a typical customer screen will now be discussed with reference to FIG. 5. A customer as defined in this submission is a user of the carrier or network service being delivered by a service provider. A service provider would be classified as a telco or cable type company.

As can be seen in FIG. 5, a typical customer screen 505 for the reference OLT (optical line terminal) is shown. This screen is accessed by selecting any specific port from the screen discussed previously with reference to FIG. 4. The customer screen 505 shows the customer name 507, address 510, and city 512, enabling the technician(s) to determine the exact location of the customer utilizing the respective service and the respective channel of each respective port. The status 515 of the port is provided to show if the service is online, offline or in some type of other status such as alarm, inactive or unused. The vendor 517 and model 520 is provided to display the name of a vendor 517 and the model 520 of the vendor device being utilized at the customer location. As an example, a typical cable tv provider may deploy more than one type of set top box in order to deliver their cable TV services. The vendor 517 and model 520 would display on the customer 505 screen accordingly, giving the technician(s) detailed information about the devices deployed at the customers respective location(s).

The port number 522 is displayed to identify the port servicing the customer network reflected in the associated fields 507, 510 and 512. This allows the technician(s) to trace the signals back to the specific PON location, port and channel to determine the source of a potential problem. The upstream transmit power 525 along with the upstream receive power 527 and the downstream receive power 530 are also displayed to give the technician(s) a clear picture of what is occurring with the respective signal levels and signal strengths. A video 532 and voice 535 alert notify the technician(s) if the associated trouble is also affecting the video 532 and/or voice 535 signals, if they are being provided by the carrier. A data alert 537 provides detailed information about the operational status of the port 522 being viewed by the technician(s). As with all monitoring and diagnostic screens provided in the fiber diagnostics system, signals that are in alarm or otherwise out of compliant service levels may be shown 540 as highlighted in a color selected by the carrier for presenting alarm indications. Typically, these colors are either yellow or red.

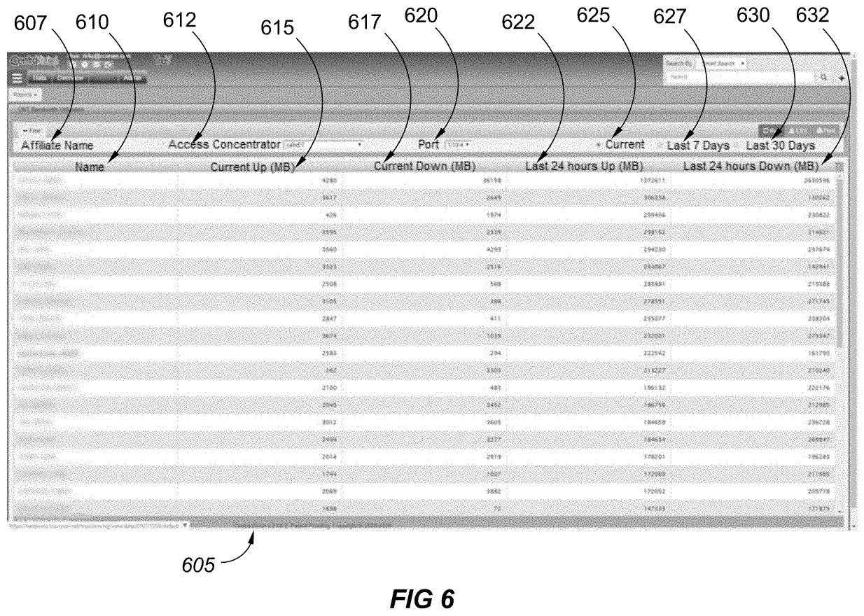

Another screen that is provided by the fiber diagnostics system shows detailed information with respect to the upstream and downstream bandwidth utilization as discussed previously with reference to FIG. 3. Selecting either the upstream or downstream bandwidth utilization discussed previously will present the technician(s) with a new screen that details the bandwidth utilization on a by user basis. This bandwidth utilization screen will now be discussed with reference to FIG. 6.

With reference to FIG. 6, an ONT bandwidth utilization screen 605 is shown. The bandwidth utilization screen 605 breaks down the information based on the affiliate 607 (the company and provider associated with the network segment), the customer name 610, the access concentrator 612 where the bandwidth is being generated from, the current upstream bandwidth 615 being used in megabits, the current downstream bandwidth 617 being used in megabits as well as the last 24 hours of upstream 622 and downstream 632 in megabits. The ONT bandwidth utilization 605 screen can also be configured to look at current 625 statistics as well as the last 7 days 627 and the last 30 days 630, giving the technician(s) a variety of data to determine bandwidth usage trending in support of enhancing the network capabilities as well as in troubleshooting and trouble prevention. By providing bandwidth utilization trending, the fiber diagnostics system can enable the provider to forecast usage and plan to support bandwidth usage needs accordingly.

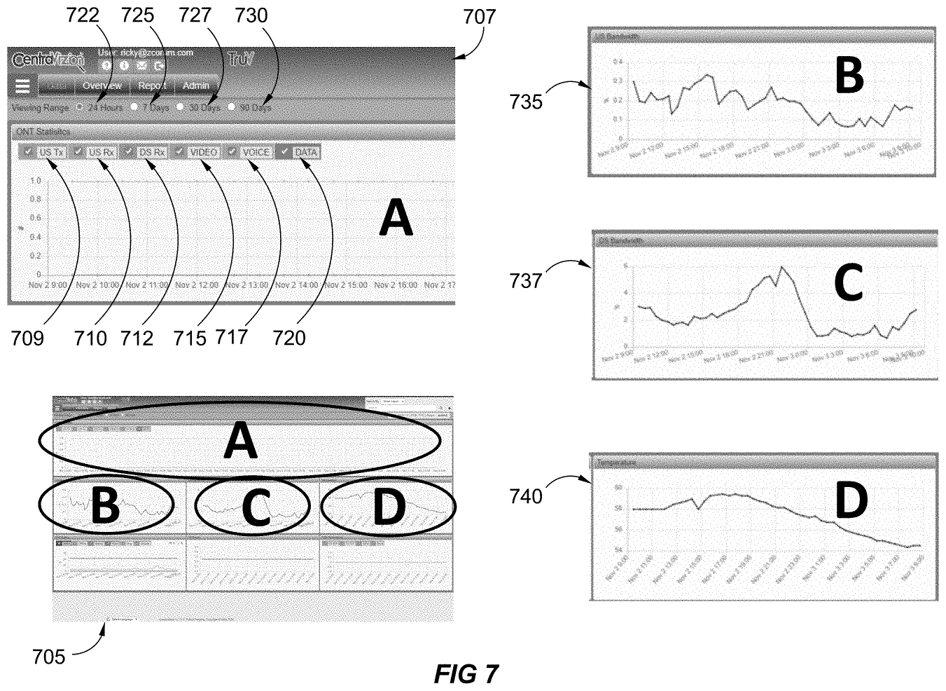

Another diagnostic screen provided by the fiber diagnostics system is the ONT statistics screen. From the data aggregation (OLT) screen discussed with reference to FIGS. 2, 3 and 4, a technician can obtain detailed information about the ONT statistics by selecting any of the fields provided on the data aggregation (OLT) screen. An exemplary embodiment of the ONT statistics screen will now be discussed with reference to FIG. 7.

With reference to FIG. 7, a typical ONT statistics screen 705 is shown. The letters (A, B, C and D) correspond to the associated exploded views of the subject ONT statistics screen 705. The top left of FIG. 7 represents the “A” 707 section of the ONT statistics screen 705. This screen 707 provides ONT statistics such as upstream transmit 709, upstream receive 710, downstream receive 72 video 715 voice 717 and data 720 metrics that are presented in the viewing window. By selecting the reference check marks (as is shown in 709, 710, 712, 715, 717 and 720) the technician(s) can select the specific signal they wish to view over the period. The viewing ranges are selectable as, for example, 24 hours 722, 7 days 725, 30 days 727 and 90 days 730. While other breakdown timeframes are available and configurable within the fiber diagnostics system, these timeframes were chosen as typical references for monitoring and collecting data over periods to determine network behaviors and trending. The upstream bandwidth 735 is displayed as a graph (B) and shows the utilization of the bandwidth in the upstream direction 735 over the period currently selected (722). In this example, the selected viewing period is 24 hours 722. The upstream bandwidth screen 735 is displaying the subject bandwidth during the selected period.

The downstream bandwidth 737 functions in an identical manner. The downstream bandwidth 737 being displayed as a graph (C) and is in reference to the selected period of 24 hours 722. The temperature 740 of the facility being monitored is also shown as a graph (D) over the selected period of 24 hours 722. By enabling details of the subject signals and data being sent over the facility to be measured over varying time intervals, the technician(s) can get a very clear picture of the facility usage and performance over any period and on any port (transmit, receive, data, upstream, downstream and the like).

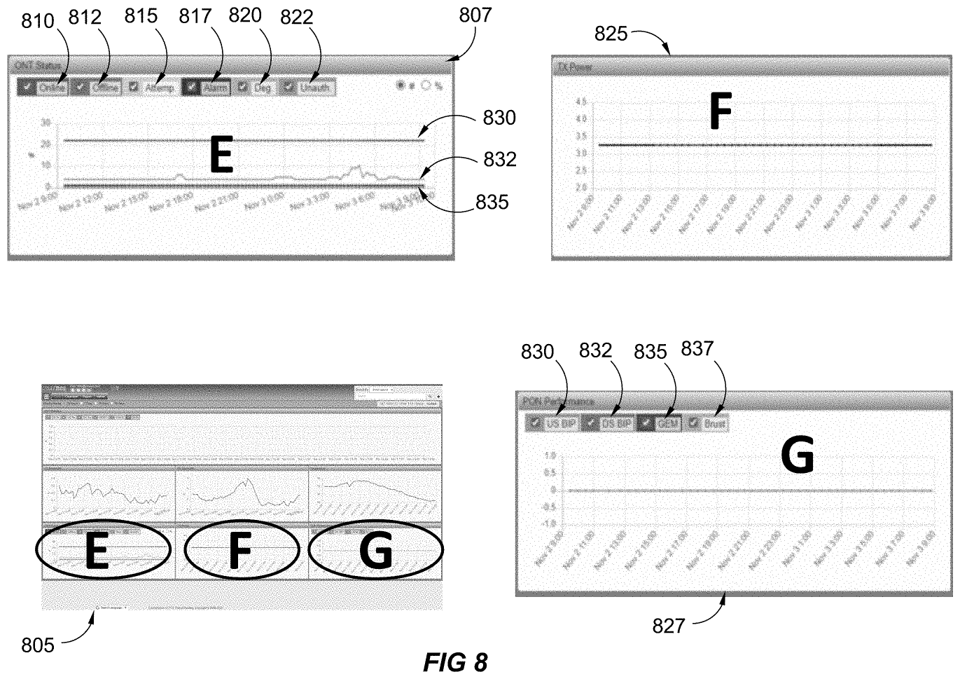

The bottom half of the subject ONT status screen 705 will now be discussed with reference to FIG. 8. As can be seen in FIG. 8, the bottom half of the ONT status screen 805 is broken out into exploded views labeled E 807, F 825 and G 827. The ONT status screen 807 allows technicians to determine what information they wish to view based on the setting provided. Specifically, technicians can view ONT status parameters such as online 810 and offline 812 status over a period, shown as a graph E. The graphs shown 830, 832 and 835 are color coded to match the selected parameter chosen by the technician(s). Additional ONT status parameters that may be selected and viewed include attempts 815 alarms 817 degrading signal levels 820 and unauthorized access attempts 822. The transmit power 825 is also shown as a graph F and displayed over the period selected with reference to FIG. 7 discussed previously. The passive optical network (PON) performance 827 may also be viewed as a graph G, and can include performance statistics such as upstream BIP 830, downstream BIP 832, GEM 835 and burst errors 837. This level of detail and granularity for error and signal types over selected periods allows detailed usage and trending statistics to be collected, as well as enabling network planners to determine overall network usage in a given area to forecast expansion needs for a given network segment.

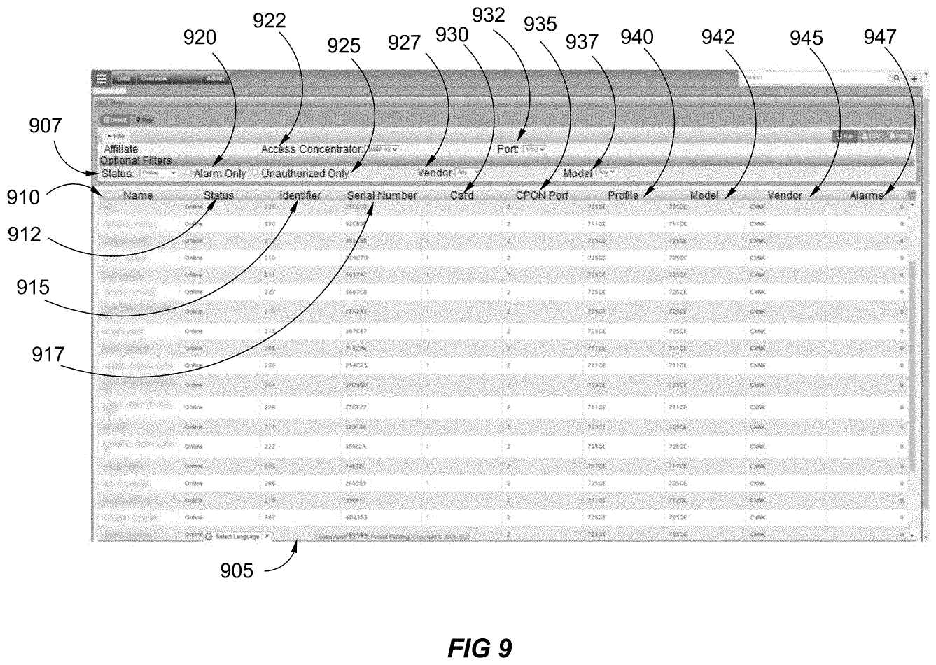

Selecting any of the parameters provided on the OLT statistic screen 805 such as columns for online 810, offline 812, attempts 815, alarms 817, degrading signal levels 820 or alarms 822 will open a more detailed view providing detailed ONT status on a by-customer basis. The detailed ONT status screen will now be discussed with reference to FIG. 9.

With reference to FIG. 9, the ONT status screen 905 provides detailed information pertaining to the functional status of the ONT being viewed. This particular view is associated with signals and services being provided to customer locations. The online or offline status 907 is provided to allow a technician to immediately determine if the ONT is available and operational. The ONT screen 905 also provides a detailed view of the customers using the services by name 910 enabling the technician(s) to select the name 910 and open a new window to see further details of the customer status as will be discussed later in this submission. The online or offline status 912 of each individual customer by name 910 is also provided. While the ONT status 907 may show the ONT device itself is online, the status 912 of each individual customer 910 may vary. An identifier 915 and serial number 917 is also provided to enable the carrier to provide a unique identification 915 and serial number 917 to each customer 910. The serial number 917 is typically associated with the CPE equipment (not shown) that is currently serving the customer 910. The card number 930 and the CPON port number 935 of the card associated with delivering the service to each customer 910 is also provided. A profile 940 number is provided to enable the technician(s) to easily view the service profile associated with the customer 910 and the model 942 and vendor 945 of the CPE equipment (not shown) providing the service to the customer.

Additional identifiers such as alarms 947 are provided to enable a quick view of any customer 910 services that are currently out of specification or otherwise showing an alarm 947 status. The technician(s) can choose to limit the view of the ONT status screen 905 to showing only those services in alarm mode by selecting alarm only 920. In a similar fashion, the technician(s) can choose to limit the view of the ONT status screen 905 to only show unauthorized access 925 or access attempts for the ONT. The technician(s) can also select which access concentrator 922 they wish to view, which vendor 927 device they wish to limit their view to, any specific vendor model 937 they wish to limit the view to as well as any port 932 they wish to view. By enabling detailed views by port 932, access concentrator 922, vendor 927 and model 937, the fiber diagnostics system provides highly detailed information at a granular level for virtually every network, circuit and network element associated with providing the service(s).

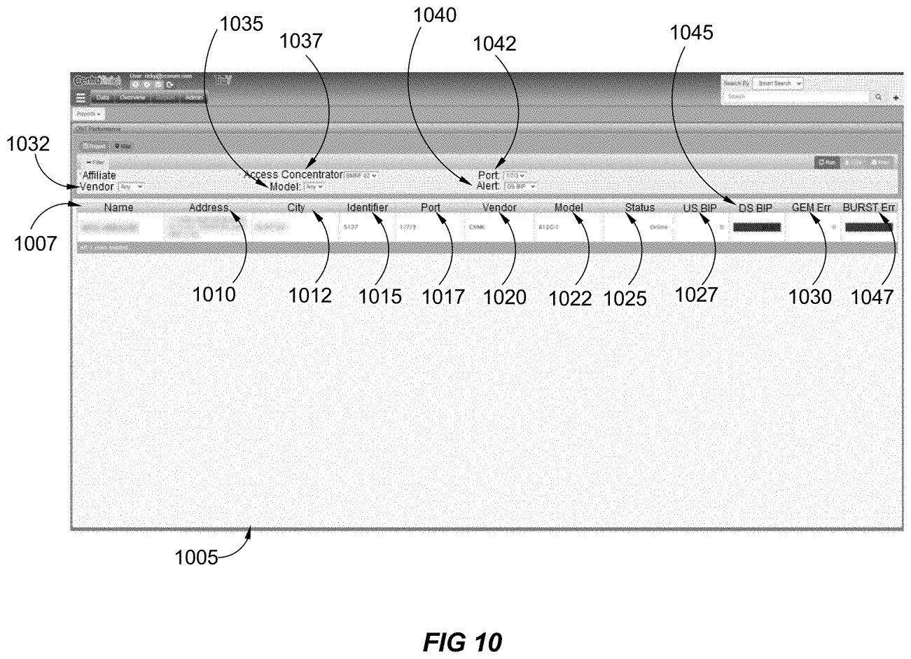

As stated previously, detailed information about each customer 910 can be viewed by selecting the respective customer 910 from the ONT status 905 screen. This opens up a new screen that provides ONT performance for the specified customer 910. The ONT performance screen will now be discussed with reference to FIG. 10.

With reference to FIG. 10, the ONT performance screen 1005 provides more detailed information about each customer. The customer chosen from the previous screen (with reference to FIG. 9) will be displayed by name 1007, address 1010 and city 1012. The identifier 1015 discussed previously will also be displayed, along with the port 1017, the vendor 1020, model number of the CPE device 1022 and the current status 1025 as being online, offline or other. Performance data is also provided to enable the technician(s) to get a clear picture of any signal information that may be out of compliance. The ONT performance 1005 screen shows upstream BIP, downstream BIP 1045 as well as GEM 030 and burst 1047 errors. Additional information provided includes the vendor 1032 of the CPE device, the model 1035 of the CPE device and port 1042 of the CPE device as well as the serving access concentrator 1037 and the type of alert status 1040 being monitored. Changing any of these fields using the associated menus (1032, 1035, 1037, 1040 and 1042) will naturally change the information provided in the fields below. The amount of detail provided by the fiber diagnostics system enables technicians to quickly isolate cases of trouble and clear them, enhancing the overall carrier service level to the customer.

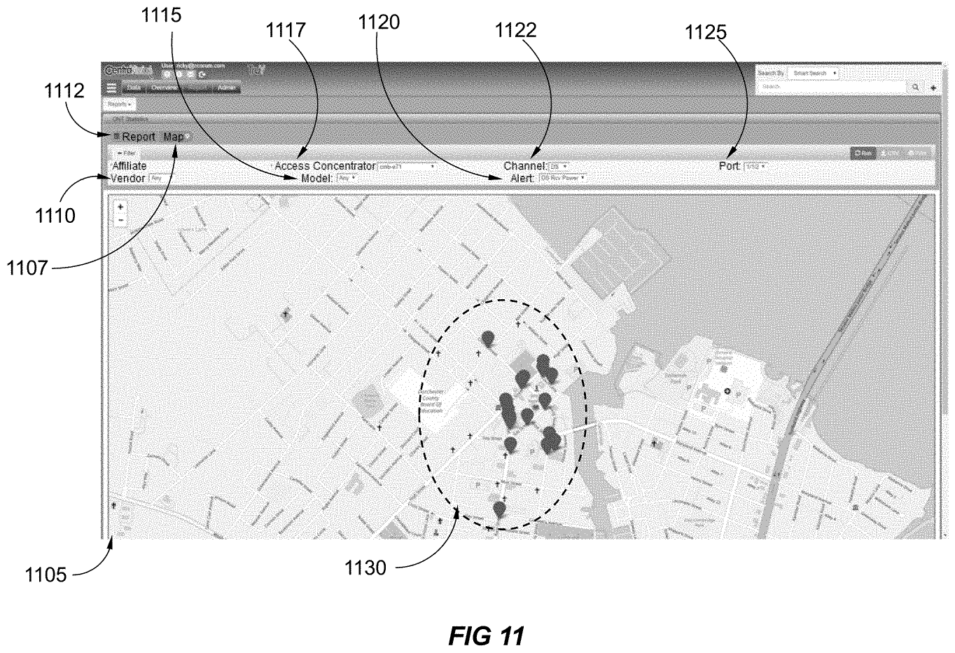

The fiber diagnostics system also provides detailed ONT status screen (discussed with reference to FIG. 9) provides a map view that enables technicians to quickly and easily locate the geographic area(s) where cases of trouble may reside. An exemplary embodiment of the ONT statistics map screen will now be discussed with reference to FIG. 11.

As can be seen in FIG. 11, a typical ONT statistics map view 1105 screen is shown. This screen is accessed from the ONT status screen (discussed with reference to FIG. 9) by selecting the map 1107 function on the screen 1105. Selecting report 1112 will return the technician(s) to the screen discussed previously with reference to FIG. 9. The ONT statistics map 1105 screen provides a geographic view 1130 of all areas of service and their current status. While the subject FIG. 11 is in black and white, the icons 1130 shown on the map 1105 screen are color coded to give the technician(s) a visual indication of exactly what is occurring at each of the locations 1130 designated. A technician selecting any of the designations 1130 from this screen will be taken to the customer screen (discussed previously with reference to FIG. 10) for a deeper look into exactly what is causing the case of trouble being investigated. Additional information provided on the ONT status map screen 1105 includes the vendor 1110 of the devices providing the services, the access concentrator 1117 serving that area, the model number 1115 of the devices providing services, the channel 1122 being utilized to provide the service as well as the port 1125 and any alarms 1120 that are selected for view. As with all diagnostics screens provided in the fiber diagnostics system, changing any of the pulldown menus 1110, 1115, 1117, 1120, 1122 or 1125 will affect the view and the resulting equipment and network components displayed accordingly.

The fiber diagnostics system also provides detailed information on the ONT (optical network terminal) serving the associated network being deployed by the carrier.

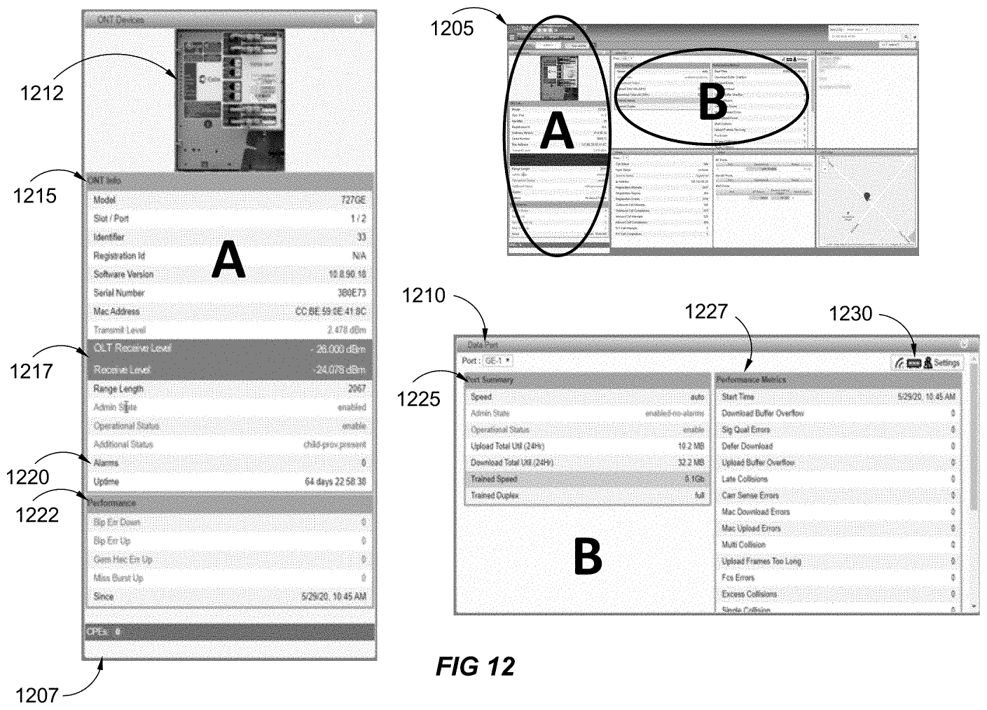

This information is provided through the ONT devices screen. An exemplary embodiment of the ONT devices screen will now be discussed with reference to FIG. 12.

As can be seen in FIG. 12 and ONT devices screen 1205 is provided. This screen provides detailed information pertaining to the ONT devices (not shown) being deployed within the carrier network. The ONT devices screen 1205 is broken into views A 1207 and B 1210 to enable easier viewing of the preferred embodiments. The ONT devices screen 1207 provides an image 1212 of the ONT device serving the network, enabling the technician(s) to get a clear image of the type of device being tested or monitored. The ONT info 1215 portion of the screen provides detailed information pertaining to the ONT device 1212 such as the model number, software version, serial number, MAC address and the like. Signals that fall outside of the specified operating parameters are shown highlighted 1217, typically in red. This gives technicians an immediate visual indication of the trouble being monitored. Alarms 1220 will also be provided visually, as will performance 1222 metrics such as the BIP errors in both upstream and downstream directions, as well as burst errors and other error codes.

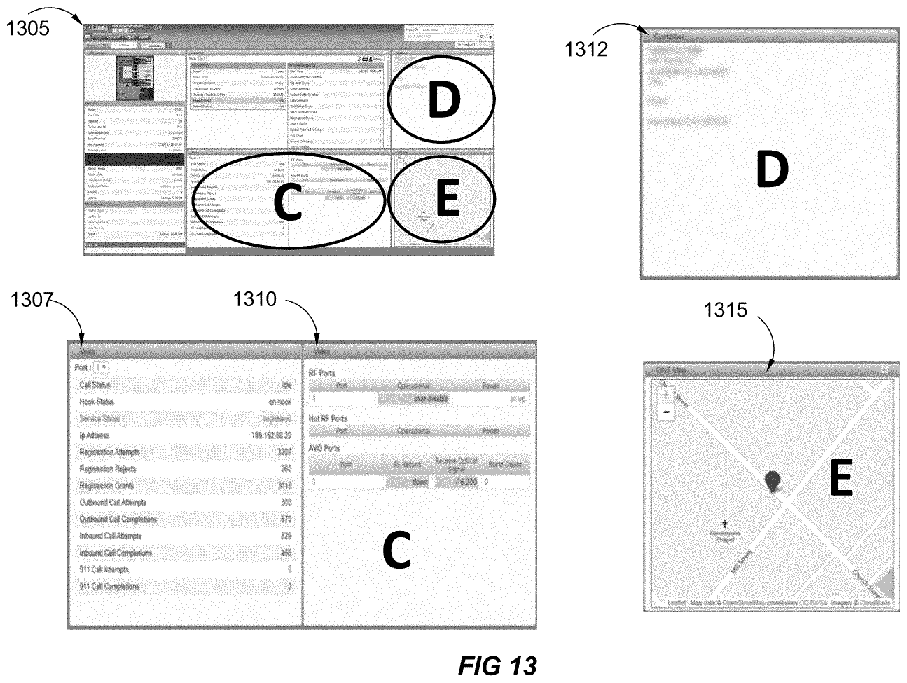

The data port 1210 B screen provides information specific to the port serving the subject network section being diagnosed. A summary 1225 of the port information is provided to include the operational status of the subject port 1225 being viewed as well as the amount of traffic, speed and other performance metrics. In addition to the port summary information 1225, the fiber diagnostics system data port view 1210 also enables technicians to see detailed performance metrics 1227 pertaining to the data port such as when the port became active, any buffer overflow, MAC download or upload errors and a host of other performance metrics related to the performance of the port being viewed. As mentioned previously, the fiber diagnostics system also enables associated third parties to access performance and service information through the system. The third party portal may be accessed by selecting the appropriate icon 1230 from the data port view 1210 of the ONT devices screen 1205. Additional ONT device screen content will now be discussed with reference to FIG. 13.

Referring to FIG. 13, the remaining sections of the ONT device screen 1305 are disclosed. The voice 1307 and video 1310 portion of the ONT devices screen 1305 provide detailed statistics and functional information pertaining to the voice 1307 signals and the video 1310 signals being provided. Information for the voice 1307 includes call status, hook status, inbound and outbound call attempts and the like. Video 1310 status information includes the power, RF ports and other detailed information enabling the technician(s) to assess the status of the video 1310 port. The ONT device screen 1305 also provides a snapshot of the customer information 1312 and the customer geographic location 1315 to give the technician immediate location and contact information enabling him/her to contact the customer and/or visit the customer location as required by the current case of trouble being diagnosed.

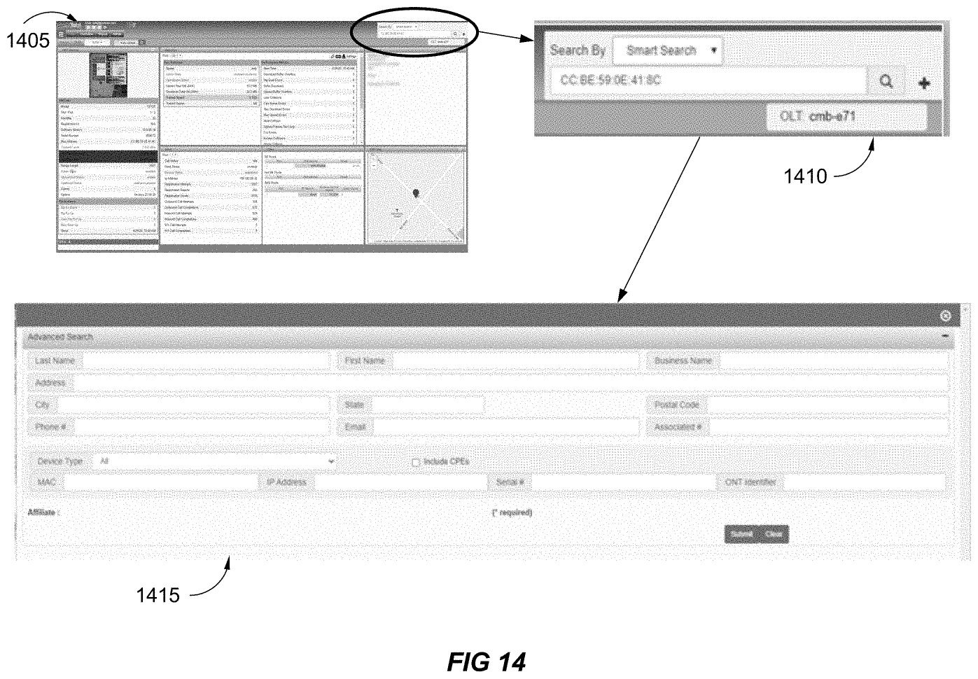

As discussed previously, the fiber diagnostics system allows for detailed search criteria to be entered enabling highly granular searches of the network and its associated facilities and components. The Search function will now be discussed with reference to FIG. 14.

As can be seen on FIG. 14, the top right-hand corner of ONT device screen 1405 provides a search function 1410 that enables the technician(s) to drill down into any network, network element, network section or client location to review devices, equipment, cables, signal levels and performance associated with the carrier service. This search window 1410 appears on all screens provided with the fiber diagnostics system, enabling a detailed search to be conducted from anywhere within the fiber diagnostics system. An exemplary advanced search screen 1415 provides the capability to search based on any customer name, location, business, telephone number, email, device type, MAC, IP address and a host of other searchable criteria. This provides the technician(s) with immediate access to any network element or any customer associated with any port and any service being provided.

The fiber diagnostics system provides a highly portable, highly searchable and detail-oriented method to test, monitor and troubleshoot any fiber network being deployed, and any facilities connected to the fiber network.

While various embodiments of the invention have been described, it will be apparent to those of ordinary skill in the art that many more embodiments and implementations are possible that are within the scope of this invention. In addition, the various features, elements, and embodiments described herein may be claimed or combined in any combination or arrangement.

What is claimed is:

1. An optical diagnostic device for a network comprising a network segment and a customer premises segment, the diagnostic device comprising:
one or more communication interfaces that connect to the network;
one or more diagnostic modules that capture, via the one or more communication interfaces, a plurality of performance metrics for communication signals in a plurality of protocols between network devices on the network segment, customer premises equipment on the customer premises segment, or both, wherein one or more of the communication signals are optical signals;
one or more storage devices that store the plurality of performance metrics;
one or more interactive user interfaces that display at least a subset of the plurality of performance metrics consisting of one or more real-time or historical performance metrics for the optical signals; and
one or more external displays that present the one or more interactive user interfaces.

2. The optical diagnostic device of claim 1, wherein the one or more interactive user interfaces are both locally and remotely accessible.

3. The optical diagnostic device of claim 1, wherein the one or more interactive user interfaces display the at least a subset of the plurality of performance metrics in graphical form.

4. The optical diagnostic device of claim 1, wherein the plurality of performance metrics are accessible via a plurality of distinct communication protocols.

5. The optical diagnostic device of claim 1, wherein the one or more performance metrics for the optical signals are optical performance metrics selected from the group consisting of optical signal levels, optical transmission power, and optical transmission errors.

6. The optical diagnostic device of claim 1, wherein the one or more communication interfaces transmit one or more configurations to configure the network devices, the customer premises equipment, or both.

7. The diagnostic device of claim 1, wherein the one or more communication interfaces are optical communication interfaces.

8. The diagnostic device of claim 1, further comprising a GPS module that provides a location of the network devices and the customer premises equipment.

9. A diagnostic device for an optical network comprising a network segment and a customer premises segment, the diagnostic device comprising:
one or more communication interfaces that connect to the optical network;
one or more diagnostic modules that capture, via the one or more communication interfaces, a plurality of performance metrics for optical communication signals in a plurality of protocols at the network segment and the customer premises segment;
one or more storage devices that store the plurality of performance metrics;
one or more interactive user interfaces that display at least a subset of the plurality of performance metrics, wherein the at least a subset of the plurality of performance metrics are real-time or historical performance metrics; and
one or more external displays that present the one or more interactive user interfaces.

10. The diagnostic device of claim 9, wherein the one or more interactive user interfaces display the plurality of performance metrics in graphical form.

11. The diagnostic device of claim 9, wherein the plurality of performance metrics are accessible via a plurality of distinct communication protocols.

12. The diagnostic device of claim 9, wherein one or more of the plurality of performance metrics are optical performance metrics selected from the group consisting of optical signal levels, optical transmission power, and optical transmission errors.

13. The diagnostic device of claim 9, further comprising a GPS module that provides a location for all devices on the network segment and the customer premises segment.

14. The diagnostic device of claim 9, wherein the one or more communication interfaces are optical communication interfaces.

15. A method for diagnosing an optical network comprising a network segment and a customer premises segment, the method comprising:
connecting to the network segment and the customer premises segment of the optical network via one or more communication interfaces;
capturing, via the one or more communication interfaces, a plurality of performance metrics for optical signals in a plurality of protocols at the network segment, the customer premises segment, or both;
storing the plurality of performance metrics on one or more storage devices;
providing one or more interactive user interfaces that display at least a subset of the plurality of performance metrics, wherein the at least a subset of the plurality of performance metrics are real-time or historical performance metrics; and
presenting the one or more interactive user interfaces via one or more external displays.

16. The method of claim 15, wherein the one or more interactive user interfaces are both locally and remotely accessible.

17. The method of claim 15, wherein the one or more interactive user interfaces display the plurality of performance metrics in graphical form.

18. The method of claim 15, wherein the plurality of performance metrics are accessible via a plurality of distinct communication protocols.

19. The method of claim 15, wherein one or more of the plurality of performance metrics are optical performance metrics selected from the group consisting of optical signal levels, optical transmission power, and optical transmission errors.

20. The method of claim 15, further comprising providing a location of all devices on the network segment and the customer premises segment via a GPS module.
